(19) United States
(12) Patent Application Publication
(10) Pub. No.: US 2024/0031457 A1
(43) Pub. Date: Jan. 25, 2024

(54) Programmable Device-Based Accelerator Framework for Virtualized Environments

(71) Applicant: Intel Corporation, Santa Clara, CA (US)

(72) Inventors: Shih-wei Chien, Zhubei (TW); Nagabhushan Chitlur, Portland, OR (US); Ajay Gupta, Portland, OR (US); Pradeep Nagarajan, San Jose, CA (US)

(21) Appl. No.: 18/478,683

(22) Filed: Sep. 29, 2023

(51) Int. Cl. H04L 69/16; H04L 69/22

(52) U.S. Cl. CPC H04L 69/161; H04L 69/22

(57) ABSTRACT

Systems or methods of the present disclosure may provide receiving a request to perform an operation on data. A data payload of the data is then transmitted to a programmable logic device using a first transfer to enable offloading of at least a portion of the operation. Then, a descriptor corresponding to a storage location of the data payload in the programmable logic device is received. Using memory accesses one or more headers are added to the data payload in the storage location. Finally, the descriptor corresponding to the data payload is transmitted without the data payload to the programmable logic device to cause the programmable logic device to transmit packets comprising the data payload and the one or more headers over a network.

### BACKGROUND

The present disclosure relates generally to programmable logic devices. More particularly, the present disclosure relates to improving throughput and reducing latency for programmable device-based accelerators, such as field programmable gate array (FPGA)-based accelerators used to perform cryptographic operations or storage accelerators like compression, encryption, erasure coding, hashing, deduplication, and the like.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Programmable logic devices, a class of integrated circuits, may be programmed to perform a wide variety of operations. For example, a design may be implemented on a programmable logic device with design software, such as computer-aided design (CAD) software used to perform storage acceleration operations. As data centers move towards disaggregated architectures where even hot data is accessed over the network, latency is becoming an issue and reducing the time taken to process a storage packet is desired. As storage throughput requirements are increasing there is a need for the storage accelerators to perform different operations like compression, encryption, erasure coding, hashing, deduplication, and the like. Some parts of storage stack run in software in the processor being assisted by the accelerator while others are to be offloaded to accelerator. Due to this mix of operation locations, there may be data movement back and forth between host memory and accelerator memory that negatively impacts overall system performance (throughput and number of I/O operations per sec), latency, memory bandwidth and power consumption, and/or other parameters. Similarly, cryptographic accelerators may provide support at different layers of the networking stack (layer 2 for MACSec, layer 3 like IPSec, layer 5 like SSL etc.). Additionally, crypto accelerators for network traffic may be part of the networking stack. As different layers of the network stack are offloaded (e.g., TCP checksum, large send offload, layer 2 packet switching) different parts of different layers of network stack are offloaded. This difference in layers that are offloaded may result in execution of a network stack pipeline where packet processing is done by the host followed by actions by accelerators followed by additional actions by the host. These alternating operations lead to constant/repeated data movement between the host and the accelerators that also negatively impacts throughput, memory bandwidth and power consumption, and/or the like. Furthermore, with more data movement back and forth, more I/O or memory operations may be required. Additionally, with the extra memory movements (e.g., direct memory accesses (DMAs)), more DMA channels may be required causing such offloading to increase a size of DMA channels consumed by the programmable logic device.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, the system including a host device and a field-programmable gate array (FPGA), in accordance with an embodiment of the present disclosure;

FIG. 2 is a block diagram of the integrated circuit device of FIG. 1, in accordance with an embodiment of the present disclosure;

FIG. 3 is a block diagram of programmable fabric of the integrated circuit device of FIG. 1, in accordance with an embodiment of the present disclosure;

FIG. 4 is a simplified block diagram of a system that includes the host and the FPGA of FIG. 1 with an operation stack that performs an operation on data in the host and a network stack in the host to prepare data for transmission over a network, in accordance with an embodiment of the present disclosure;

FIG. 5 is a simplified block diagram of a system that includes the host and the FPGA of FIG. 1 using the FPGA to offload/hardware accelerate some of the operation of FIG. 4, in accordance with an embodiment of the present disclosure;

FIG. 6 is a simplified block diagram of a system that includes the host and the FPGA of FIG. 1 using the FPGA to offload/hardware accelerate some of the operation of FIG. 4 with a network stack implemented in the FPGA, in accordance with an embodiment of the present disclosure;

FIG. 7 is a simplified block diagram of a system that includes the host and the FPGA of FIG. 1 using the FPGA to offload/hardware accelerate some of the operation of FIG. 4 and splitting the data and control planes of an operation between the FPGA and the host in separate flows, in accordance with an embodiment of the present disclosure;

FIG. 8 is a block diagram of an example of the system of FIG. 7 where a transport layer security (TLS)/secure sockets layer (SSL) application provides data/buffers to a TLS stack with encryption to be offloaded to the FPGA of FIG. 1, in accordance with an embodiment of the present disclosure;

FIG. 9 is a block diagram of an example of the system of FIG. 7 where a transport layer security (TLS)/secure sockets layer (SSL) application receives data from a TLS stack with decryption to be offloaded to the FPGA of FIG. 1, in accordance with an embodiment of the present disclosure;

FIG. 10 is a block diagram of an example of the system of FIG. 7 where storage compression is to be offloaded to the FPGA of FIG. 1, in accordance with an embodiment of the present disclosure; and

FIG. 11 is a block diagram of a data processing system including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure describes systems and techniques related to providing acceleration (e.g., cryptographic, storage, etc.) with reduced data movement between different memory domains. Such reduced data movement may occur due to a protocol, such as Compute Express Link (CXL) that allows a host (e.g., central processing unit (CPU), system on a chip (SoC), etc.) and that programmable device-based accelerator to directly access the same memory enabling transfer control to coordinate read/write as processing of packets proceeds. Such a configuration also allows each compute domain (e.g. the host and the accelerator) to be used more effectively. For instance, a general purpose processor may be used for packet processing in software, and the accelerator(s) may be used for specialized functions like encryption/decryption, message digest, authentication, compression, erasure coding, accelerator for networking stack (e.g., TCP large send offload, TCP checksum, etc.), and the like.

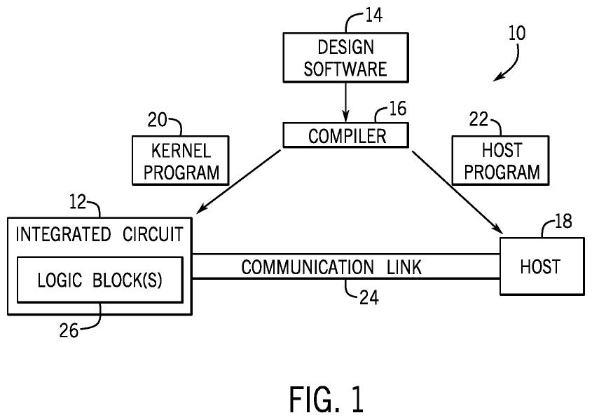

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may include a host processor, such as a central processing unit (CPU), a system on a chip (SoC), and/or any other processor types. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

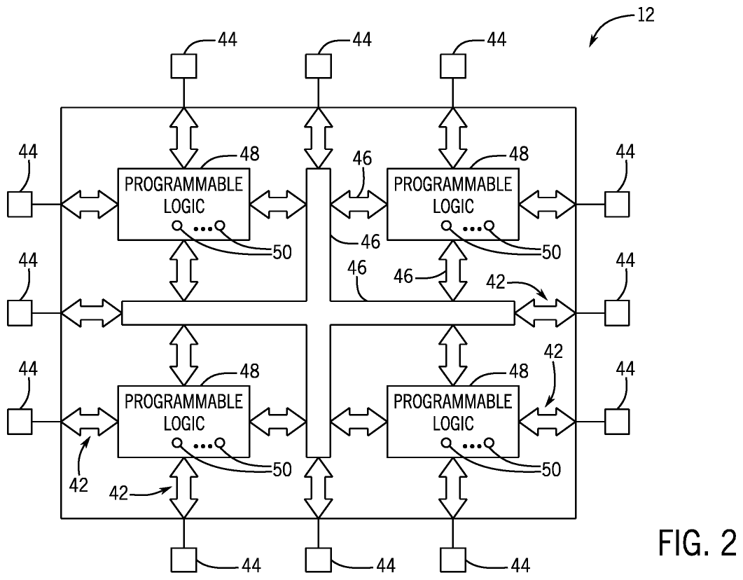

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on the integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

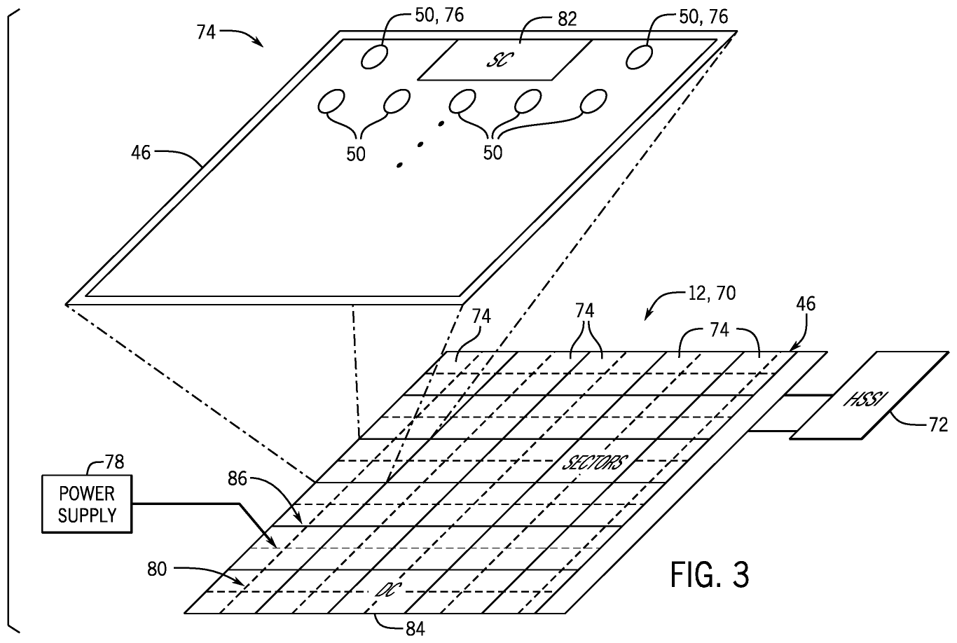

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and Designer Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

As discussed above, some embodiments of the programmable logic fabric may be configured using indirect configuration techniques. For example, an external host device may communicate configuration data packets to configuration management hardware of the FPGA 70. The data packets may be communicated internally using data paths and specific firmware, which are generally customized for communicating the configuration data packets and may be based on particular host device drivers (e.g., for compatibility). Customization may further be associated with specific device tape outs, often resulting in high costs for the specific tape outs and/or reduced scalability of the FPGA 70.

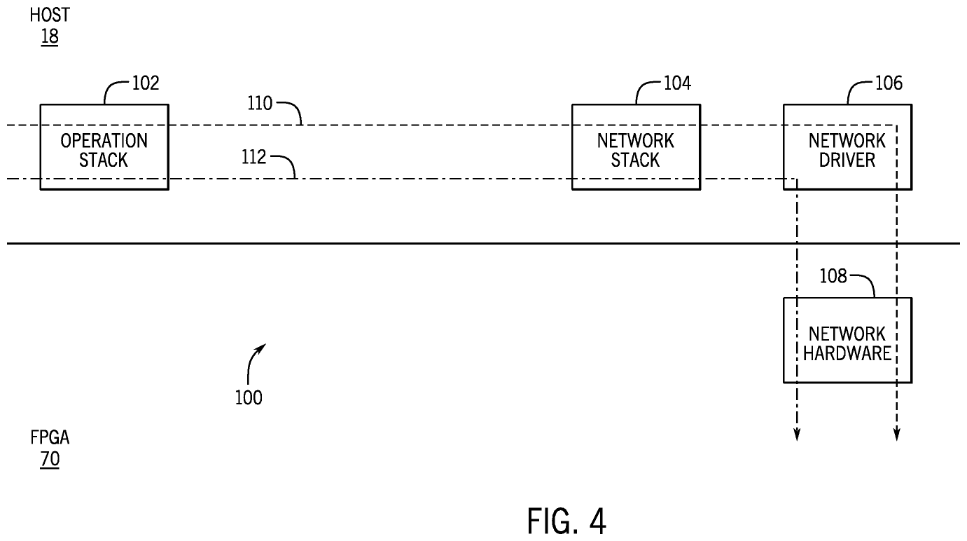

FIG. 4 is a simplified block diagram of a system 100 that includes the host 18 and the FPGA 70. As illustrated, network traffic may originate in a container and/or VM running on the host 18. Some operation may be performed on the data using an operation stack 102. For example, many different types of data may be secured via encryption, decryption, and/or hashing in the operation stack 102. Additionally or alternatively, the operation stack 102 may be used to manage storage such as compression or other storage operations. A network stack 104 may be used to perform network operations (e.g., packet formatting) according to a corresponding protocol (e.g., TCP/IP) in preparation for a network driver 106 to drive packets out to a network over network hardware 108, illustrated as implemented in the FPGA 70. The data in packets proceed along flow 110 and controls proceed along flow 112. As illustrated by the flows 110 and 112, both the data and the controls are transferred from the domain of the host 18 to the FPGA 70 only once from the network driver 106.

In the simplified block diagram of the system 100 and/or the following FIGS., each of the stacks may be implemented in software (e.g., executed on the host 18), hardware circuitry, and/or a combination thereof. Furthermore, the network hardware 108 (and/or other blocks designated as “hardware”) may be implemented using hardware circuitry and/or software. Moreover, in some embodiments of the following FIGS., there may be one or more stacks for at least some of the operations illustrated as using a single stack.

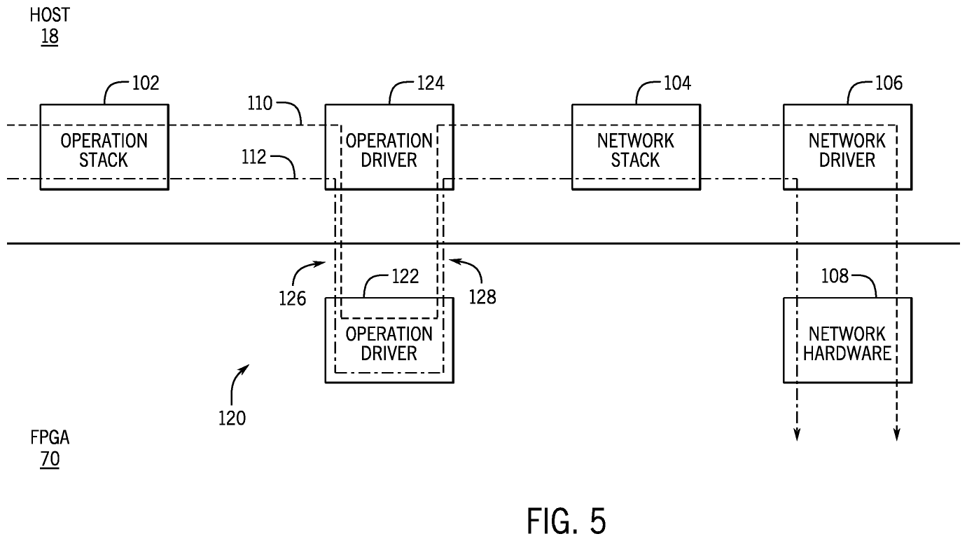

FIG. 5 is a simplified block diagram of a system 120 that includes the host 18 and the FPGA 70 with at least some functionality offloaded to the FPGA 70. As illustrated, network traffic may originate in a container and/or VM running on the host 18. As previously noted, some operation (e.g., cryptographic or storage operations) may be performed on the data using an operation stack 102 using offloading/acceleration using operation hardware 122 implemented on the FPGA 70. The operation hardware 122 may include circuitry of the FPGA 70 programmed to assist the host 18 in performing an operation (e.g., cryptographic, storage, or other operations). An operation driver 124 may be used to prepare data and transmit data in a first transmission 126 (e.g., DMA) to the operation hardware 122 and to receive data in a transmission 128 (e.g., DMA) from the operation hardware 122.

Like in the system 100, the network stack 104 may be used to perform network operations (e.g., packet formatting) according to a corresponding protocol (e.g., TCP/IP) in preparation for a network driver 106 to drive packets out to a network over network hardware 108, illustrated as implemented in the FPGA 70. The data in packets proceed along flow 110 and controls proceed along flow 112. As illustrated by the flows 110 and 112, both the data and the controls are transferred from the domain of the host 18 to the FPGA 70 to the host 18 and back to the FPGA 70 before transmission from the network hardware 108. Thus, the addition of the offloading acceleration using the operation hardware approximately triples the amount of data to be transmitted via DMA between the host 18 and the FPGA 70. This leads to significant and inefficient bandwidth consumption due to the back and forth movement of the data between the domains of the host 18 and the FPGA 70.

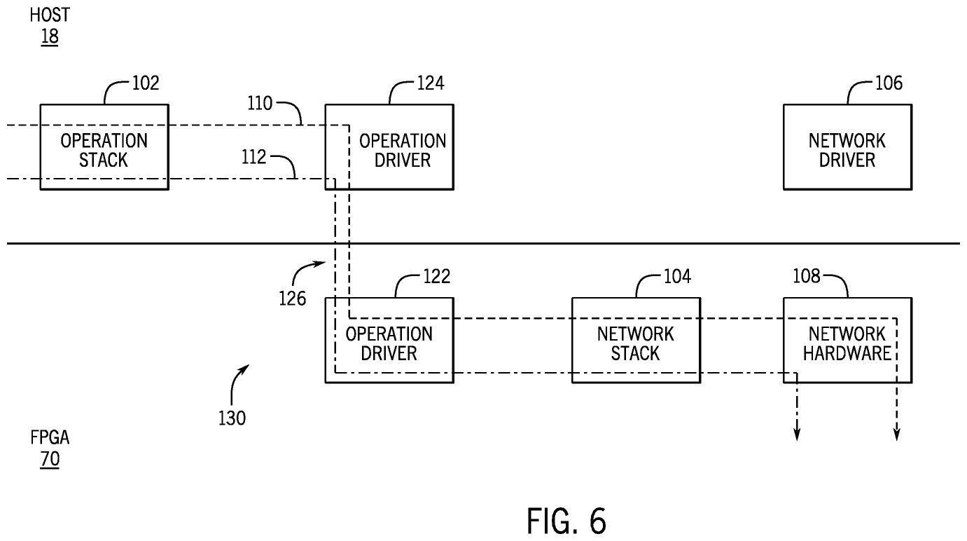

FIG. 6 is a simplified block diagram of a system 130 that includes the host 18 and the FPGA 70 with at least some functionality offloaded to the FPGA 70. As illustrated, network traffic may originate in a container and/or VM running on the host 18. As previously noted, some operation (e.g., cryptographic or storage operations) may be performed on the data using an operation stack 102 using offloading/acceleration using operation hardware 122 implemented on the FPGA 70. In the system 130, the network stack 104 is offloaded to the FPGA 70 along with the operation performed by the operation hardware 122. As previously noted, the operation hardware 122 may include circuitry of the FPGA 70 programmed to assist the host 18 in performing an operation (e.g., cryptographic, storage, or other operations). An operation driver 124 may be used to prepare data and transmit data in the first transmission 126 (e.g., DMA) to the operation hardware 122. The second transmission 128 is omitted in the system 130 by offloading the network stack 104 to the FPGA 70.

Like in the system 100, the network stack 104 may be used to perform network operations (e.g., packet formatting) according to a corresponding protocol (e.g., TCP/IP) in preparation to drive packets out to a network using network hardware 108. However, implementing some protocols (e.g., TCP/IP) may be typically implemented in software due to inefficient implementation in hardware and/or the FPGA 70 due to a wide array of congestion algorithms that may be applied to the packets.

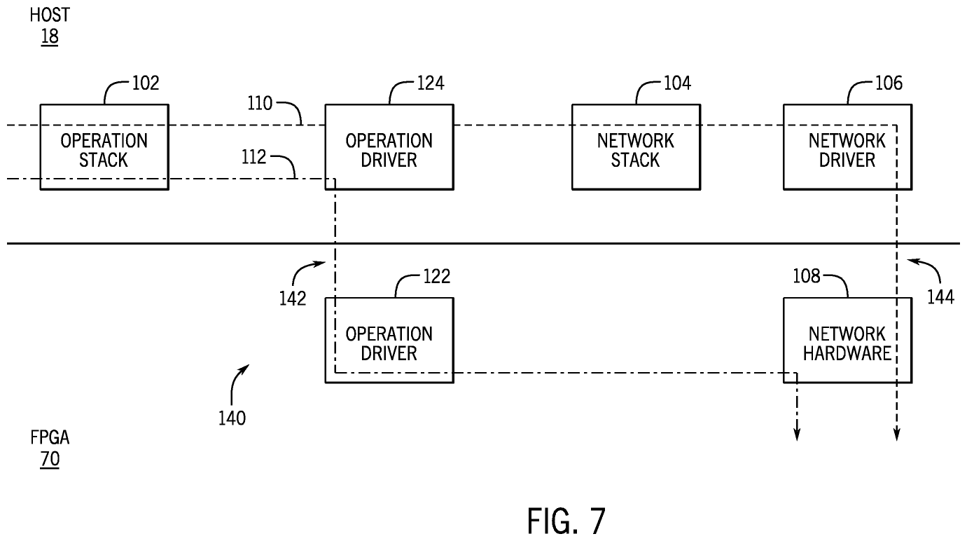

FIG. 7 is a simplified block diagram of a system 140 that includes the host 18 and the FPGA 70 with at least some functionality offloaded to the FPGA 70. Like the previous FIGS. 4-6, network traffic may originate in a container and/or VM running on the host 18. As previously noted, some operation (e.g., cryptographic or storage operations) may be performed on the data using an operation stack 102 using offloading/acceleration using operation hardware 122 implemented on the FPGA 70. However, in FIG. 7, the amount of movement of data packets is the same as that of the system 100 of FIG. 4 that used no offloading/hardware acceleration. Specifically, the data packet is transferred in transmission 142. The difference in transmission 142 and the transmission 126 of FIGS. 5 and 6 is that the transmission 142 sends the data separate from the controls as illustrated by the respective flows 112 and 110. Likewise, transmission 144 includes a transmission of the controls without the data meaning that there is only one transfer of the data payload. As discussed below, such an implementation may be achieved using a compute express link (CXL) type 3 device where packet buffers are stored in the FPGA 70 and accessible by the host 18 using CXL interfaces. Using the CXL interfaces, the host 18 may access the information it needs without transferring the data back and forth between the domains of the host 18 and the FPGA 70. Compared to the offloading/hardware acceleration of FIGS. 5 and 6, the system 140 performs such operation with a reduced latency/bandwidth consumption. Thus, separating the control and data flows enables fewer data transfers to perform hardware accelerated operations.

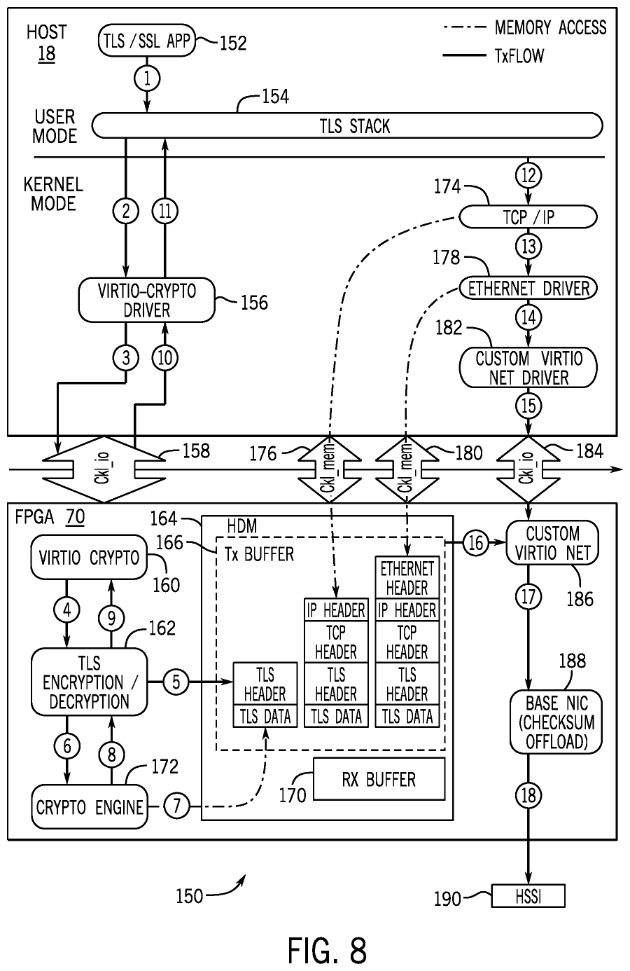

FIG. 8 is a block diagram of an example system 150 where a transport layer security (TLS)/secure sockets layer (SSL) application 152 provides buffers to a TLS stack 154 as Step 1 in a data transmission where data egresses from the system 150. The TLS stack 154 is responsible for implementing various TLS protocols, such as Application, Alert, ChangeCipherSpec, handshake, and the like. Furthermore, the TLS stack 154 generates a TLS record protocol including headers and performing fragmentation. Some aspects (e.g., MAC and encryption) may be offloaded to the FPGA 70. To perform the offloading, a Virtio-crypto driver 156 of the host 18 receivers (Step 2) descriptors from the TLS stack 154 for sending (Step 3) the TLS offload descriptor via a CXL I/O interface/port 158 to Virtio Crypto logic 160 implemented in the FPGA 70. As used herein, descriptors may be pointers or indicators that indicate a location of where data/metadata is stored, to be stored, or to be accessed. The Virtio-crypto driver 156 is responsible for descriptors for performing DMA operations of TLS packets to the FPGA 70. The Virtio Crypto logic 160 takes cryptographic descriptors and performs the DMA operations of the TLS packets to the FPGA 70 over the CXL I/O interface/port 158. The Virtio Crypto logic 160 also transmits (Step 4) TLS descriptors, headers, and payloads to TLS encryption/decryption logic 162 implemented in the programmable fabric of the FPGA 70. The TLS encryption/decryption logic 162 may include any suitable encryption standard, such as advanced encryption standard (AES) 128, 192, or 256. The TLS encryption/decryption logic 162 sends (Step 5) TLS headers to host-managed device memory (HDM) 164 stored on the FPGA 70. The HDM 164 includes a transmission buffer (Tx Buffer) 166 where the TLS headers are stored and also a receiver buffer (Rx Buffer) 170 where incoming data is buffered. In some embodiments, the TLS headers are written to the Tx Buffer 166 from the Virtio Crypto logic 160.

The TLS encryption/decryption logic 162 also generates per-packet keys, generates initialization vectors, and sends (Step 6) the data payload to a crypto engine 172. The crypto engine 172 may be implemented in the programmable fabric of the FPGA 70 and is responsible for actual encryption/decryption. The crypto engine receives input buffers/payloads and meta data (e.g., per-packet key, destination buffer address, etc.) from the TLS encryption/decryption logic 162. The crypto engine 172 writes (Step 7) encrypted data into the Tx Buffer 166. As discussed below, for encrypted traffic received from the network, the crypto engine 172 may decrypt such data. The crypto engine 172 sends (Step 8) the descriptor to the TLS encryption/decryption logic 162 to indicate that encryption has occurred. The TLS encryption/decryption logic 162 then sends (Step 9) the descriptor to the Virtio Crypto logic 160. The Virtio Crypto logic 160 sends (Step 10) the descriptor to the Virtio-crypto driver 156, and the Virtio-crypto driver 156 sends (Step 11) the descriptor to the TLS stack 154.

Steps 2-11 pertain to the flow 112 of data. Steps 12-15 pertain to the flow 110 in the control plane. As illustrated, the TLS stack 154 transmits (Step 12) data (e.g., metadata) to a TCP/IP stack 174 to cause it to perform protocol processing, such as fragmentation, reassembly, generating packet headers, or other TCP/IP operations. The TCP/IP stack 174 uses a memory access (e.g., read and/or write) of the Tx Buffer 166 via CXL memory interface/port 176 to perform such processing. The TCP/IP stack 174 sends (Step 13) an indicator to an Ethernet driver 178 to cause the Ethernet driver to perform L2 protocol processing using a memory access (e.g., read and/or write) of the HDM 164 via CXL memory interface/port 180. The Ethernet driver 178 also sends descriptors (Step 14) to a custom Virtio Net driver 182. The custom Virtio Net driver 182 is a special driver that sends and receives descriptors while the actual packets stay in the HDM 164. Thus, only the descriptor uses a DMA operation (Step 15) via a CXL I/O interface/port 184 to be transmitted to custom Virtio Net 186 that is implemented in the FPGA 70. The custom Virtio Net 186 is responsible for processing the descriptors and reading the packet (Step 16) for any offload for L2/L3/L4 processing, such as TCP checksum, large packet send, and the like. The data buffers point to the Tx Buffer 166. Thus, no DMA need be performed for the data payload from the custom Virtio Net driver 182 to the custom Virtio Net 186 for a data egress flow to the network. For data ingress, the custom Virtio Net 186 writes the data payload to the HDM 164 (e.g., Rx Buffer 170). A base network interface controller (NIC) 188 may be implemented in the FPGA 70 to receive the packet (Step 17) from the custom Virtio Net 186. The NIC 188 is responsible for any L2/L3/L4 offload processing that may typically be handled by the host 18, such as TCP checksum, large send offload, adding virtual local area network (VLAN)/virtual extensible local area network (VxLAN) headers, and the like. The NIC 188 is also responsible for sending the packet (Step 18) to the PHY layer 190, such as a high-speed serial interface (HSSI) or any other suitable transport to the network.

Although specific protocols, such as TLS or Virtio, other encryption and/or storage device virtualization protocols may be used similarly. Furthermore, in some embodiments, the previously discussed drivers may be software drivers, hardware drivers, firmware drivers, or any combination thereof. Moreover, in some embodiments, the CXL I/O interface/port 158 may be the same as the CXL I/O interface/port 184 or may be different interfaces/ports. Similarly, in some embodiments, the CXL memory interface/port 176 may be the same or different than the CXL memory interface/port 180.

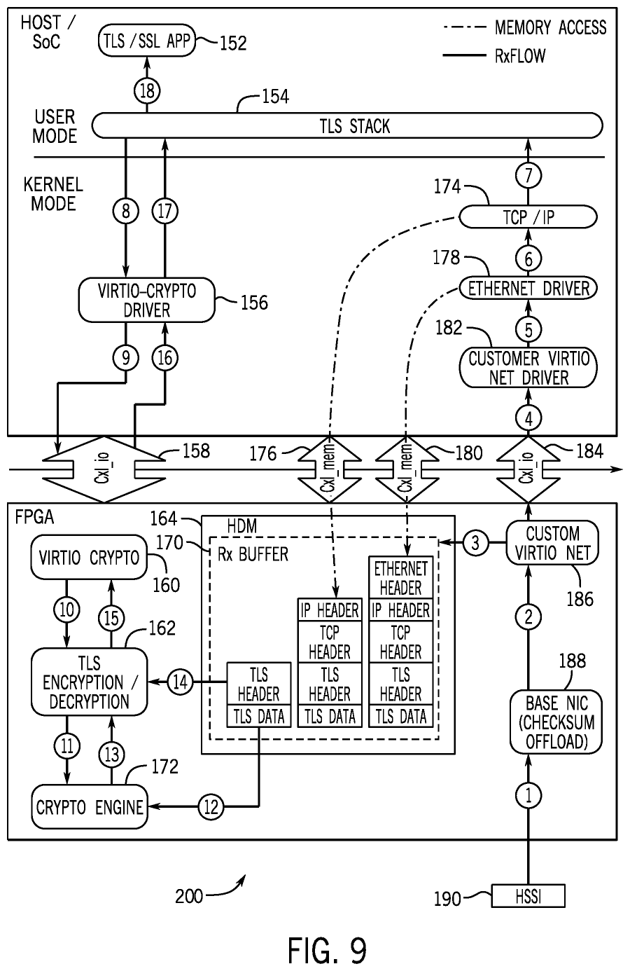

FIG. 9 is a block diagram of an example system 200 where a transport layer security (TLS)/secure sockets layer (SSL) application 152 is to receive data from the network via the PHY layer 190 as Step 1 in data ingressing into the system 200. The system 200 may include the same elements as are in the system 200 used to implement the operation illustrated in FIG. 7. The Base NIC 188 then performs any appropriate offloaded tasks (e.g TCP checksum) and transmits (Step 2) the packet to the custom Virtio Net 186 that writes (Step 3) the data packet to the HDM 164. The custom Virtio Net 186 also writes (Step 4) the descriptor from the packet through the CXL I/O interface/port 184. As such, the custom Virtio Net 186 may DMA the descriptor without moving the data payload to the host 18. The custom Virtio Net Driver 182 sends (Step 5) the descriptor to the Ethernet driver 178 that, in turn, sends (Step 6) the descriptor to the TCP/IP stack 174. The Ethernet driver 178 and the TCP/IP stack 174 may perform respective protocol operations using their respective CXL memory interfaces/ports 180 and 176. The TCP/IP stack 174 sends (Step 7) the descriptor to the TLS stack 154. The TLS stack 154 sends (Step 8) the descriptor to the Virtio-crypto driver 156. The Virtio-crypto driver 156 sends (Step 9) the descriptor to the Virtio Crypto logic 160 via the CXL I/O interface/port 158. For instance, the transfer may include a DMA operation of the descriptor without the payload. The Virtio Crypto logic 160 sends (Step 10) the descriptor to TLS encryption/decryption logic 162 that, in turn, sends (Step 11) the descriptor to the crypto engine 172. The crypto engine 172 reads (Step 12) the encrypted payload from the HDM 164 and decrypts it. The crypto engine 172 then sends (Step 13) the decrypted payload to the TLS encryption/decryption logic 162 that reads (Step 14) the header from HDM 164 and sends (Step 15) the header, decrypted payload, and the descriptor to the Virtio Crypto logic 160. The Virtio Crypto logic 160 then sends (Step 16) the header, decrypted payload, and the descriptor to the Virtio-Crypto driver 156. For instance, the header, decrypted payload, and the descriptor may be transferred via the CXL I/O interface/port 158 using only a single DMA of the payload across the boundary between the FPGA 70 and the host 18 for a data ingress. The TLS stack 154 receives (Step 17) the header, decrypted payload, and the descriptor and sends (Step 18) the decrypted payload to the TLS/SSL application 152 for use.

FIGS. 8 and 9 clearly show how the pipeline of packet processing seamlessly transitions between the host 18 and the FPGA 70 with the packet payload in the HDM 164 with network packet headers generated in the HDM 164 during transmission reducing bandwidth consumption for data movement for data ingress and egress. Specifically, as disclosed herein, this usage of a CXL type 3 device enables the host 18 to directly read/write into HDM 164 in the FPGA 70. In some embodiments, coordination of read and/or write operations between domains may be managed via a doorbell or other mechanism between the compute domains of the host 18 and the FPGA 70.

In a virtualized environment different virtual machines (VMs) may have different utilizations of different pipelines with some components common in the host 18 and others different between the different pipelines. For example, a first VM may be set to use TLS offloading while another VM may be set to use older versions of SSL. The FPGA 70 may be loaded with configurations for both operations simultaneously or at different times. Furthermore, one could also partition other cryptographic protocols like IPsec protocol where the IPsec protocol handling is done in software in the host 18, but encryption/decryption handling or any other operation is offloaded to the FPGA 70 with seamless transition of control between the domain of the host 18 and the domain of the FPGA 70 with data packets shared across both domains in the HDM 164 as discussed above.

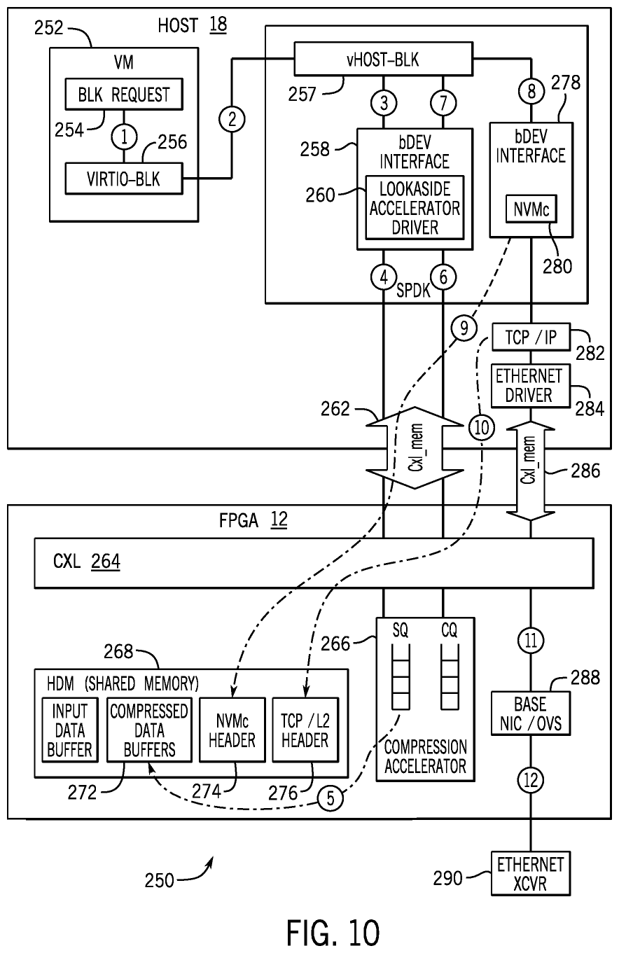

As previously noted, accelerator types in addition to or alternative to cryptographic accelerators may be used. For instance, a storage accelerator using a CXL type 3 memory device may be used to move the data once from host memory from an application to device memory with transformations on the data being done in the device memory using CXL memory protocol interactions before the data is sent over the network. The illustrated operation is referred to as compression as a particular example, but similar techniques may be applied to any other suitable storage acceleration types like encryption/decryption, erasure coding, and the like. FIG. 10 is a block diagram of an example system 250 that uses storage offloading/hardware acceleration. A VM 252 includes an application 254 that sends (Step 1) a block request to a Virtio-Blk 256 to send blk data. The Virtio-Blk 256 is an emulation of a hardware storage controller for virtualization in the VM 252. The Virtio-Blk 256 sends data to a vhost-blk 257 using a vhost protocol. The vhost-blk 257 may be an in-kernel Virtio-blk device accelerator. The vhost-blk 257 requests (Step 3) via a storage performance development kit (SPDK) block device layer (bdev) interface 258. The bdev interface includes a lookaside accelerator driver (260) that enables the vhost-blk 257 to request for data to be accelerated to SPDK. The lookaside accelerator driver 260 may send (Step 4) a descriptor via a CXL memory interface/port 262 of a CXL interface 264 to a compression accelerator 266. As previously noted, any other suitable accelerator, such as encryption, deletion, or any other suitable acceleration operation may be performed by the compression accelerator 266 in addition to or alternative to compression.

Once the descriptor(s) are written to a submission queue (SQ) of the compression accelerator 266, the host 18 may notify the compression accelerator 266 to read and act on the descriptor. One way this notification can be completed may be via multiple-input and multiple-output using CXL memory operations and respective ports/interfaces. The compression accelerator 266 sends (Step 5) data from the domain of the host 18 to a host-managed device memory (HDM) 268 on the FPGA 70 and performs compression (and/or other operations) on the data in compressed data buffers 272. In some embodiments, the sending of the data to the HDM 268 may be performed using a DMA operation. The FPGA 70 then sends (Step 6) a completion descriptor to the host 18 via the CXL memory interface/port 262. The lookaside accelerator driver 260 then notifies (Step 7) the vhost-blk 257. The vhost-blk 257 then sends (Step 8) a non-volatile memory express (NVMe) command to bdev interface 278 to send the data via NVMe over TCP to the network. An NVMe driver 280 of the bdev interface 278 then adds (Step 9) NVMe header 274 to the HDM 268. Similarly, a TCP\IP driver 282 adds (Step 10) a TCP/IP header 276 to the HDM 268. An Ethernet driver 284 may also add an Ethernet header to the HDM 268. The Ethernet driver 284 also sends (Step 11) a descriptor via a CXL memory interface/port 286 to a Base NIC/Open vSwitch (OVS) 288 to send packets to the network with a data buffer pointing to the data in the HDM 268. The Base NIC/OVS 288 may also perform further transformation (e.g., adding a VLAN or VxLAN) for the packets. The Base NIC/OVS 288 further sends (Step 12) the packets over an Ethernet transceiver (Xcvr) 290 to the network.

In summary, the uncompressed data moves once from host 18 to the FPGA 70 and then all transformations and packet header processing is performed in the HDM 268 that is in the domain of the FPGA 70. After such transformations and packet header processing, the final data is sent over the network. This operation on data in the HDM 268 reduces the data movement significantly leading to higher throughput, higher number of input/output operations per second (IOPS) for storage, lower latency, and lower power consumption among other benefits.

Although the various preceding figures discuss specific orders of steps, in some embodiments, at least some of the steps may be performed in a different order than described, such as two steps may be performed simultaneously or in an opposite order than that described.

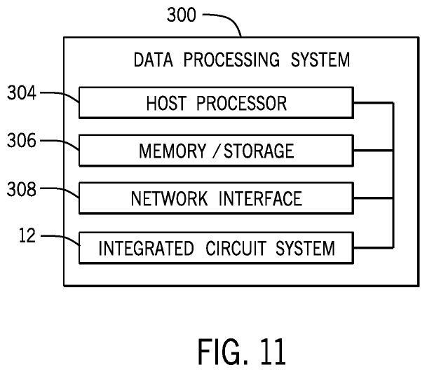

Bearing the foregoing in mind, the integrated circuit device 12 may be a component included in a data processing system, such as a data processing system 300, shown in FIG. 11. The data processing system 300 may include the integrated circuit device 12 (e.g., a programmable logic device), a host processor 304 (e.g., host 18), memory and/or storage circuitry 306, and a network interface 308. The data processing system 300 may include more or fewer components (e.g., electronic display, designer interface structures, ASICs). Moreover, any of the circuit components depicted in FIG. 11 may include integrated circuits (e.g., integrated circuit device 12). The host processor 304 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 306 may include random access memory (RAM), read-only memory (ROM), one or more hard drives, flash memory, or the like. The memory and/or storage circuitry 306 may hold data to be processed by the data processing system 300. In certain embodiments, the memory and/or storage circuitry 306 may store instructions, that when executed by the host processor 304, causes the host processor 304 (e.g., host 18) to perform any of the operations discussed herein. In some cases, the memory and/or storage circuitry 306 may also store configuration programs (bit streams) for programming the integrated circuit device 12. The network interface 308 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

In one example, the data processing system 300 may be part of a data center that processes a variety of different requests. For instance, the data processing system 300 may receive a data processing request via the network interface 308 to perform encryption, decryption, machine learning, video processing, voice recognition, image recognition, data compression, database search ranking, bioinformatics, network security pattern identification, spatial navigation, digital signal processing, or some other specialized task.

The above discussion has been provided by way of example. Indeed, the embodiments of this disclosure may be susceptible to a variety of modifications and alternative forms. While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A tangible, non-transitory, and computer-readable medium, storing instructions thereon, wherein the instructions, when executed, are to cause a processor to receive a request to perform an operation on data, transmit a data payload of the data to a programmable logic device using a first transfer to enable offloading of at least a portion of the operation, receive a descriptor corresponding to a storage location of the data payload in the programmable logic device, use memory accesses to add one or more headers to the data payload in the storage location, and transmit the descriptor corresponding to the data payload without transmitting the data payload to the programmable logic device to cause the programmable logic device to transmit packets comprising the data payload and the one or more headers over a network.

EXAMPLE EMBODIMENT 2. The tangible, non-transitory, and computer-readable medium of example embodiment 1, where the programmable logic device includes a compute express link (CXL) type 3 device where the programmable logic device exposes memory on the programmable logic device as host-managed device memory (HDM) to be managed by the processor.

EXAMPLE EMBODIMENT 3. The tangible, non-transitory, and computer-readable medium of example embodiment 2, where the CXL type 3 device includes a field-programmable gate array (FPGA).

EXAMPLE EMBODIMENT 4. The tangible, non-transitory, and computer-readable medium of example embodiment 1, where the first transfer includes a direct memory access.

EXAMPLE EMBODIMENT 5. The tangible, non-transitory, and computer-readable medium of example embodiment 1, where the one or more headers include TCP/IP headers, and adding the one or more headers includes using a TCP/IP stack to add the TCP/IP headers to the data payload in the programmable logic device.

EXAMPLE EMBODIMENT 6. The tangible, non-transitory, and computer-readable medium of example embodiment 5, where adding the TCP/IP headers includes using a compute express link memory operation.

EXAMPLE EMBODIMENT 7. The tangible, non-transitory, and computer-readable medium of example embodiment 1, where the one or more headers includes Ethernet headers, and adding the one or more headers includes using an Ethernet driver to add the Ethernet headers to the data payload in the programmable logic device.

EXAMPLE EMBODIMENT 8. The tangible, non-transitory, and computer-readable medium of example embodiment 7, where adding the Ethernet headers includes using a compute express link memory operation.

EXAMPLE EMBODIMENT 9. The tangible, non-transitory, and computer-readable medium of example embodiment 1, where the operation includes compression of the data payload, encryption of the data payload, or decryption of the data payload.

EXAMPLE EMBODIMENT 10. The tangible, non-transitory, and computer-readable medium of example embodiment 8, wherein the instructions, when executed, are to cause the processor to transfer the descriptor to the programmable logic device to cause the programmable logic device to add an encryption header to the data payload in the programmable logic device.

EXAMPLE EMBODIMENT 11. A method may include receiving, at a processor, a request to perform an operation on data, separating, using the processor, a data payload and control plane of the data, transmitting the data payload and a descriptor for the data from the processor to a programmable logic device in a first transfer to enable hardware acceleration of the operation using the programmable logic device, receiving, at the processor, the descriptor corresponding to a storage location of the data payload in the programmable logic device, using the processor to perform memory accesses to add one or more headers to the data payload in the storage location of the programmable logic device, and transmitting the descriptor corresponding to the data payload through an interface without transferring the data payload to the programmable logic device to cause the programmable logic device to transmit packets comprising the data payload and the one or more headers over a network.

EXAMPLE EMBODIMENT 12. The method of example embodiment 11, where the programmable logic device includes a compute express link (CXL) type 3 device where the programmable logic device exposes memory on the programmable logic device as host-managed device memory (HDM) to be managed by the processor.

EXAMPLE EMBODIMENT 13. The method of example embodiment 12, where the one or more headers include TCP/IP headers, and adding the one or more headers includes using a TCP/IP stack to add the TCP/IP headers to the data payload in the HDM.

EXAMPLE EMBODIMENT 14. The method of example embodiment 12, where the one or more headers includes Ethernet headers, and adding the one or more headers includes using an Ethernet driver to add the Ethernet headers to the data payload in the HDM.

EXAMPLE EMBODIMENT 15. The method of example embodiment 11, where receiving the descriptor indicates that the data payload has been encrypted in the programmable logic device.

EXAMPLE EMBODIMENT 16. The method of example embodiment 11, where the operation includes performing encryption or data compression acceleration using the programmable logic device by transferring the data payload between the processor and the programmable logic device only one time per data payload.

EXAMPLE EMBODIMENT 17. A programmable logic device may include a network PHY layer to receive a data packet from a network connection, a memory to store a data payload of the data packet in a receiver buffer, a network interface controller implemented in the programmable logic device to receive the data packet from the network PHY layer, network logic implemented in the programmable logic device to write the data packet to the memory and to transmit a descriptor corresponding the data packet to a host device, one or more memory interfaces that are to expose the memory to the host device as a host-managed memory (HDM) and receive one or more headers from the host device to be stored in the receiver buffer, operation logic implemented in the programmable logic device to receive the descriptor from the host device indicating that the one or more headers have been stored in the receiver buffer, and an operation engine implemented in the programmable logic device to receive the descriptor from the operation logic and perform an operation on the data payload in the receiver buffer based at least in part on receiving the descriptor.

EXAMPLE EMBODIMENT 18. The programmable logic device of example embodiment 17, where the network interface controller performs TCP checksum operations as offloaded from the host device.

EXAMPLE EMBODIMENT 19. The programmable logic device of example embodiment 17, where the data payload is not transferred to the host device by the network logic with the descriptor.

EXAMPLE EMBODIMENT 20. The programmable logic device of example embodiment 17, where the operation includes a decryption operation to be performed on the data payload to generate decrypted data, and the operation logic is configured to transfer the decrypted data, the descriptor, and the one or more headers to the host device.

What is claimed is:

1. A tangible, non-transitory, and computer-readable medium, storing instructions thereon, wherein the instructions, when executed, are to cause a processor to:
receive a request to perform an operation on data;
transmit a data payload of the data to a programmable logic device using a first transfer to enable offloading of at least a portion of the operation;
receive a descriptor corresponding to a storage location of the data payload in the programmable logic device;
use memory accesses to add one or more headers to the data payload in the storage location; and
transmit the descriptor corresponding to the data payload without transmitting the data payload to the programmable logic device to cause the programmable logic device to transmit packets comprising the data payload and the one or more headers over a network.

2. The tangible, non-transitory, and computer-readable medium of claim 1, wherein the programmable logic device comprises a compute express link (CXL) type 3 device where the programmable logic device exposes memory on the programmable logic device as host-managed device memory (HDM) to be managed by the processor.

3. The tangible, non-transitory, and computer-readable medium of claim 2, wherein the CXL type 3 device comprises a field-programmable gate array (FPGA).

4. The tangible, non-transitory, and computer-readable medium of claim 1, wherein the first transfer comprises a direct memory access.

5. The tangible, non-transitory, and computer-readable medium of claim 1, wherein the one or more headers comprises TCP/IP headers, and adding the one or more headers comprises using a TCP/IP stack to add the TCP/IP headers to the data payload in the programmable logic device.

6. The tangible, non-transitory, and computer-readable medium of claim 5, wherein adding the TCP/IP headers comprises using a compute express link memory operation.

7. The tangible, non-transitory, and computer-readable medium of claim 1, wherein the one or more headers comprises Ethernet headers, and adding the one or more headers comprises using an Ethernet driver to add the Ethernet headers to the data payload in the programmable logic device.

8. The tangible, non-transitory, and computer-readable medium of claim 7, wherein adding the Ethernet headers comprises using a compute express link memory operation.

9. The tangible, non-transitory, and computer-readable medium of claim 1, wherein the operation comprises compression of the data payload, encryption of the data payload, or decryption of the data payload.

10. The tangible, non-transitory, and computer-readable medium of claim 8, wherein the instructions, when executed, are to cause the processor to transfer the descriptor to the programmable logic device to cause the programmable logic device to add an encryption header to the data payload in the programmable logic device.

11. A method, comprising:
receiving, at a processor, a request to perform an operation on data;
separating, using the processor, a data payload and control plane of the data;
transmitting the data payload and a descriptor for the data from the processor to a programmable logic device in a first transfer to enable hardware acceleration of the operation using the programmable logic device;
receiving, at the processor, the descriptor corresponding to a storage location of the data payload in the programmable logic device;
using the processor to perform memory accesses to add one or more headers to the data payload in the storage location of the programmable logic device; and
transmitting the descriptor corresponding to the data payload through an interface without transferring the data payload to the programmable logic device to cause the programmable logic device to transmit packets comprising the data payload and the one or more headers over a network.

12. The method of claim 11, wherein the programmable logic device comprises a compute express link (CXL) type 3 device where the programmable logic device exposes memory on the programmable logic device as host-managed device memory (HDM) to be managed by the processor.

13. The method of claim 12, wherein the one or more headers comprises TCP/IP headers, and adding the one or more headers comprises using a TCP/IP stack to add the TCP/IP headers to the data payload in the HDM.

14. The method of claim 12, wherein the one or more headers comprises Ethernet headers, and adding the one or more headers comprises using an Ethernet driver to add the Ethernet headers to the data payload in the HDM.

15. The method of claim 11, wherein receiving the descriptor indicates that the data payload has been encrypted in the programmable logic device.

16. The method of claim 11, wherein the operation comprises performing encryption or data compression acceleration using the programmable logic device by transferring the data payload between the processor and the programmable logic device only one time per data payload.

17. A programmable logic device, comprising:
a network PHY layer to receive a data packet from a network connection;
a memory to store a data payload of the data packet in a receiver buffer;
a network interface controller implemented in the programmable logic device to receive the data packet from the network PHY layer;
network logic implemented in the programmable logic device to write the data packet to the memory and to transmit a descriptor corresponding the data packet to a host device;
one or more memory interfaces that are to expose the memory to the host device as a host-managed memory (HDM) and receive one or more headers from the host device to be stored in the receiver buffer;
operation logic implemented in the programmable logic device to receive the descriptor from the host device indicating that the one or more headers have been stored in the receiver buffer; and
an operation engine implemented in the programmable logic device to receive the descriptor from the operation logic and perform an operation on the data payload in the receiver buffer based at least in part on receiving the descriptor.

18. The programmable logic device of claim 17, wherein the network interface controller performs TCP checksum operations as offloaded from the host device.

19. The programmable logic device of claim 17, wherein the data payload is not transferred to the host device by the network logic with the descriptor.

20. The programmable logic device of claim 17, wherein the operation comprises a decryption operation to be performed on the data payload to generate decrypted data, and the operation logic is configured to transfer the decrypted data, the descriptor, and the one or more headers to the host device.
